(19) United States
(12) Patent Application Publication
(10) Pub. No.: US 2025/0253787 A1
(43) Pub. Date: Aug. 7, 2025

(54) METHOD FOR CONTROLLING AN OPERATION OF AN ELECTRIC MACHINE

(71) Applicant: ZF Friedrichshafen AG, Friedrichshafen (DE)

(72) Inventors: Florian ULLRICH, Gerolzhofen (DE); Sebastian WENDEL, Arnstein (DE); Hans-Dieter ENDRES, Volkach (DE); Andreas KRÄMER, Bad Neustadt (DE)

(21) Appl. No.: 19/044,251

(22) Filed: Feb. 3, 2025

(30) Foreign Application Priority Data
Feb. 7, 2024 (DE) 10 2024 201 099.5

(51) Int. Cl. H02P 21/00; B60L 3/00; B60L 15/02; H02P 21/14; H02P 27/06

(52) U.S. Cl. CPC H02P 21/0021; B60L 3/0061; B60L 15/025; H02P 21/14; H02P 27/06; B60L 2240/429; B60L 2240/526

(57) ABSTRACT

A method for controlling an operation of an electric machine, particularly of a motor vehicle, in a fault condition includes
detecting a present current vector of the electric machine;
determining a variation voltage vector depending on the detected present current vector;
changing the present operating point of the electric machine to a changed operating point by positioning the variation voltage vector, wherein the power generated by the change in the operating point is equal to the power loss, particularly the thermal power loss, of the electric machine, or is less than the power loss, particularly the thermal power loss, of the electric machine; and
executing an active short-circuit state proceeding from the changed operating point.

### BACKGROUND OF THE INVENTION

### 1. Field of the Invention

The disclosure is directed to a method for controlling an operation of an electric machine, particularly of a motor vehicle, in a fault condition.

### 2. Description of Related Art

Methods for controlling the operation of electric machines, in particular for motor vehicles, in which a fault condition occurs in operation are known in principle from the prior art. For example, it is known that when a fault condition occurs the electric machine or the drive arrangement comprising it is to be brought into a safe state. To this end, for example, the present operation is adjusted and the electric machine is operated such that the DC link is discharged for passing into the safe state. In particular, a so-called “active short-circuit state” (ASC) in which, for example, the high-side switches and the low-side switches of the inverter associated with the electric machine are switched simultaneously is carried out for passing into the safe state. In other words, the phases of the electric machine are short-circuited in order to pass into the safe state.

Depending on the operating state from which the safe state is moved, i.e., the operating state in which the fault condition occurs, it is possible that high transient currents which can generate a strong opposing field in the electric machine are produced by carrying out the active short-circuit state, particularly when the electrical energy storage is uncoupled or “dumped” under the fault condition. Particularly when the operating temperature of the electric machine is elevated, for example, in case the electric machine was previously in continuous operation, the opposing fields can potentially lead to a demagnetization of the permanent magnets of the electric machine, particularly the permanent magnets in the rotor, at the elevated operating temperature. In order to prevent this, permanent magnets are used which have rare earths which increase the demagnetization strength of the permanent magnets. In other words, by utilizing permanent magnets having rare earths, particularly terbium and dysprosium, demagnetization of the permanent magnets can be reliably prevented even at elevated operating temperatures when comparatively strong opposing fields are generated.

However, efforts have been made in the prior art to dispense with the use of rare earths as far as possible. This means that, by doing away with rare earths, a demagnetization of the permanent magnets of the electric machine can potentially occur at elevated operating temperatures owing to the generation of opposing fields which can lead to damage or destruction of the electric machine, particularly the permanent magnets thereof. In other words, by reducing or eliminating the aforementioned rare earths, there is a higher probability for demagnetization of the permanent magnets at higher magnet temperatures with the accompanying opposing fields.

### SUMMARY OF THE INVENTION

One aspect of the invention to provide a method for controlling the operation of an electric machine in a fault condition that is improved over the prior art and in which, in particular, the use of rare earths can at least be reduced without risking a demagnetization of the permanent magnets.

As was described above, one aspect of the invention is directed to a method for controlling an operation of an electric machine, particularly an electric machine of a motor vehicle, in a fault condition. The electric machine may be a component part of an electric drive arrangement of the motor vehicle, i.e., the motor vehicle can be driven by the electric machine as drive device. The usual components, for example, an inverter, an electrical energy storage and the like, are associated with the electric machine in the drive arrangement. The control of the operation of the electric machine can be carried out in particular by the inverter in that the inverter outputs corresponding electric voltages to adjust currents in the electric machine. As was described above, the electric machine is to be moved into a safe state, particularly by executing an active short-circuit state, when a fault condition occurs.

One aspect of the invention is based on the insight that the method comprises the following:
detecting a present current vector of the electric machine;
determining a variation voltage vector depending on the detected present current vector;
changing the present operating point of the electric machine to a changed operating point by positioning the variation voltage vector, wherein the power generated by the change in the operating point is equal to the power loss, particularly the thermal power loss, of the electric machine, or is less than the power loss, particularly the thermal power loss, of the electric machine;
executing an active short-circuit state proceeding from the changed operating point.

Accordingly, it is suggested that the present current vector of the electric machine is detected initially. In particular, the position of the current vector in a defined coordinate system, particularly an alpha-beta coordinate system or a dq coordinate system, is detected. Subsequently, depending on the detected present current director, a variation voltage vector is determined. In so doing, the position of the variation voltage vector in the above-described coordinate system can in turn be determined, particularly in relation to the previously detected present current vector. For example, the variation voltage vector has a fixed position relative to the detected present current vector.

Subsequently, the present operating point of the electric machine is changed in a power-neutral manner to a changed operating point of the electric machine in that the previously determined variation voltage vector is positioned, and the power loss in the electric machine at least offsets or exceeds the power generated by the change in the operating point. In a special case, the change in the operating point may therefore be referred to as “power-neutral”. This means, for example, that the present operating point of the electric machine is changed by positioning the variation voltage vector in a changed operating point, specifically in such a way that not more than the thermal power loss resulting from this is generated. In other words, the variation voltage vector is positioned in the control of the electric machine and accordingly brings about a change in the operating point starting from the present operating point into the changed operating point. The change in the operating point prevents transient overcurrents so that transient currents in the electric machine are prevented from generating an opposing field which could demagnetize the permanent magnets in the electric machine. Further, the variation voltage vector is selected in such a way that it carries out the change in the operating point without power.

Accordingly, the electric machine or the electric drive arrangement can be provided for carrying out the active short-circuit state in which the above-described changed operating point is adopted. The changed operating point can lie, for example, as close as possible to a steady state AC current or a stationary ASC current with respect to the dq current coordinate system. Considering this coordinate system, the changeover into the changed operating point is not linear but rather follows a curved path in the dq coordinate system. By changing the operating point into the changed operating point, the active short-circuit state can subsequently be carried out starting from the changed operating point without high transient currents in the electric machine which can generate comparatively strong opposing fields.

Accordingly, bringing the electric machine into the safe state by carrying out the active short-circuit state in determined fault conditions is also made possible for electric machines which have either no rare earths or a reduced proportion of rare earths compared with electric machines known from the prior art.

As has already been described, the variation voltage vector is determined on the basis of the detected present current vector. In an embodiment form of the method, the variation voltage vector can be determined with a defined phase shift, particularly in the range of +/−π/2 in relation to the detected current vector. It is well known that, as a result of a defined phase shift between the current vector and the voltage vector, in this case, the variation voltage vector, in this range or around the above-described defined phase shift, no power is generated.

Further, it is possible to adjust the defined phase shift so that it is not exactly +/−π/2 but rather diverges selectively therefrom. Although low power is generated in this way, it is compensated by the losses within the electric machine. This makes it possible to improve the change of the operating point to the changed operating point starting from the present operating point. In particular, the low generation of power which is compensated by the losses within the electric machine enables a closer approximation to the target operating point, particularly the steady state AC current or the center point of the spiral in the dq current coordinate system.

Purely by way of example, the defined phase shift between the variation voltage vector and the detected current vector can comprise a phase angle of 250° to 270°, particularly 255° to 265°. As has already been described, the exact phase angle or the exact phase shift can be adjusted depending on the losses in the electric machine. The higher the losses, the more power can be generated because this power can be compensated by the losses. In other words, the higher the losses in the electric machine, the greater the distance of the phase shift can be from π/2.

The described method can be further developed such that the variation voltage vector is shifted by an additional shift relative to the detected current vector depending on at least one power dissipation element. The defined phase shift can accordingly include the additional shift. The power dissipation element can form an additional element, for example, within the electric arrangement, for example, a resistor, a varistor or the like, through which electrical power can be consumed or can be converted into power dissipation. In particular, the power dissipation element can transform electrical energy into heat and accordingly discharge it into the environment. For example, the power dissipation element can be arranged in parallel with the DC link in order that the power generated by positioning the variation voltage vector is selectively dissipated in the form of power loss when changing to the changed operating state.

In a further aspect of the method, it can be provided that a discharge voltage vector is positioned before positioning the variation voltage vector in order to reduce the voltage, particularly depending on the detected current vector. Depending on the present operating state existing when the fault condition occurs or when the fault condition is detected, it can be useful to initially reduce the DC link voltage in the DC link or selectively bring about a voltage drop in order to position the variation voltage vector subsequently.

If the present voltage exceeds a fixed voltage limit in the fault condition, for example, a permissible DC link voltage, the direct positioning of the variation voltage vector can cause an additional increase in voltage. In order to ensure that the variation voltage vector can be positioned without negative consequences, the voltage is initially reduced by positioning the discharge voltage vector so that the variation voltage vector can subsequently be reliably positioned. The discharge voltage vector can be positioned particularly in such a way that the voltage phasor and the current vector are approximately synchronized or run synchronously in order to selectively generate an active power to bring about the voltage drop.

In the above-described configuration, it can be provided in particular that the discharge voltage vector is positioned on a static state vector bounding the vector sector in which the present current vector is detected. As has been described, an active power is to be selectively generated for a period of time by the discharge voltage vector in order to bring about a voltage drop so that the variation voltage vector can subsequently be reliably carried out or positioned. By occupying the static state vector, it is advantageously possible that the switch positions in the inverter can remain static for the duration over which the discharge voltage vector is applied.

In other words, it is not necessary to generate the discharge voltage vector by modulating or changing the switch positions of the switch elements of the inverter, but rather the discharge voltage vector can be selectively placed or positioned as such on a static state vector. To this end, the present current vector can be detected as was previously described. In this way, the vector sector of the hexagon describing the switch positions of the inverter can be identified in the coordinate system of the present current vector. On this basis, the discharge voltage vector can be positioned on that static state vector which bounds the present vector sector in which the present current vector was detected. In particular, the discharge voltage vector is positioned on the static state vector which trails the current vector or rearwardly bounds the vector sector. Thanks to the described setting of the discharge voltage vector on the static state vector in particular, neither a control/adjustment nor a modulation of the voltage vector is required, but rather the discharge voltage vector can be positioned in a particularly quick and simple manner, i.e., in particular with minimal computing time and computing power.

It can further be provided in the method that an electric decoupling of an electrical energy storage and/or an operational event of the electric machine and/or of the motor vehicle having the electric machine, is detected as fault condition particularly depending on an operating temperature of the electric machine. As was already described in the introduction, the detection of the fault condition can form the trigger for carrying out the method. In this regard, the method can be carried out in particular exclusively when an electric decoupling of the electrical energy storage from which the electric machine is supplied or in which the electric machine can supply energy through recuperation is decoupled or the decoupling is imminent.

In this case, in particular, it is impossible that electrical energy can be drawn from the electrical energy storage for the operation of the electric machine or the change of the operating state, or that electrical energy can be fed into the electrical energy storage in a generator mode of the electric machine. As a result, an impermissible voltage increase occurs during a change in the operating point before ASC circuit by another method. A direct ASC circuit (not preceded by a change in the operating point) would prevent this, but high transient currents occur which in turn bring about strong opposing fields. On the other hand, if the electrical energy storage is not decoupled, methods other than the method described herein can also be employed because, in this case, there is no need to take into account the generated power when changing the present operating point.

Further, the fault condition can be detected as an operational event of the electric machine and/or of the motor vehicle having the electric machine. Such fault conditions can be, for example, accident states or crash states. In particular, the present operational event of the electric machine can be included in the fault condition, i.e., whether the electric machine is operated in a motor mode or in a generator mode. As has already been described, in generator mode in particular the DC link can be charged, namely, when the electrical energy storage is decoupled.

It can also be useful to carry out the method described above in motor mode, since, for example, the control of the voltage no longer functions flawlessly because, for example, controlled variables are no longer supplied to the voltage vector. As was previously described, the discharge voltage vector can be carried out as an option in the cases described above, although it is not necessary in all actual operating states or operational events. Further, the operating temperature of the electric machine can be taken into account in all states when the fault condition is detected. If the operating temperature is below a temperature limit then, for example, execution of the method can possibly be dispensed with because a demagnetization is not possible below the temperature limit as the case may be. Otherwise, for example, when the temperature limit value is exceeded, the method can be carried out for preventing a demagnetization of the electric machine in order to change the present operating point to the changed operating point and only then adopt or carry out the active short-circuit state.

In addition, the described method can be further developed in that the discharge voltage vector and/or the variation voltage vector are positioned for a defined period of time or variable period of time, particularly depending on a present operating point. In the first alternative, a defined time period can be set for the discharge voltage vector and/or the variation voltage vector for which the vectors can be positioned. In this respect, a first time period or discharge time period can be set for the discharge voltage vector insofar as it is positioned. Further, a second time period or variation time period which can be distinct from the first time period can be set for the variation voltage vector.

According to one aspect, it can be provided that the defined time period, i.e., the first time period and/or the second time period, can be fixed depending on a present operating point. This means, for example, that the first time period and/or the second time period can be changed depending on current and/or depending on voltage. Depending on the present voltage level, the discharge voltage vector can be positioned for a longer or shorter period of time, for example. Also, depending on current, for example, at high currents, a longer time period can be determined for positioning the variation voltage vector or, at lower currents, a shorter time period can be fixed for positioning the variation voltage vector. As has already been described, the transition into the active short-circuit state is carried out after the variation voltage vector is positioned, namely, after the changed operating point is adopted.

In addition, it can be provided in the method that the discharge voltage vector and/or the variation voltage vector are positioned statically or updated, particularly based on a change in the current vector. According to the first variant, the discharge voltage vector and/or the variation voltage vector can be positioned statically. This means that they are determined and remain unchanged over the duration of the process. In other words, the discharge voltage vector and/or the variation voltage vector are positioned statically once and not changed until the voltage has been sufficiently reduced through the discharge voltage vector or until the changed operating state has been reached by positioning the variation voltage vector.

In one aspect, it can be provided that the discharge voltage vector and/or the variation voltage vector can be updated. For example, a change in the current vector can be detected for the duration of the positioning of the discharge voltage vector and/or of the variation voltage vector. As has already been described, the discharge voltage vector and/or the variation voltage vector can be determined based on the detected current vector. Accordingly, by detecting the change in the current vector, different discharge voltage vectors and variation voltage vectors can be determined and positioned at different times, i.e., they can be updated together with the current vector, or the discharge voltage vector and/or the variation voltage vector can be positioned in such a way that it or they “rotate along with” the current vector.

Moreover, the method can be further developed in such a way that the discharge voltage vector and/or the variation voltage vector are determined cyclically, particularly before the fault condition occurs. In other words, the determination can be carried out cyclically throughout the operation of the electric machine so that the corresponding discharge voltage vector and/or variation voltage vector are always already determined for the actual operating state, i.e., the presently detected current vector. As soon as a fault condition occurs or has been detected, the discharge voltage vector determined last and/or the variation voltage vector determined last can be positioned without additional computing effort or lost time. This reduces computing time and the time involved in the determination process when the fault condition occurs or when the fault condition is detected. Instead, vectors which have already been determined can be accessed and they can be directly positioned.

Besides the method described above, one aspect of the invention is directed to a control device for controlling an operation of an electric machine, particularly of a motor vehicle, in a fault condition. The control device is configured to detect a present current vector of the electric machine, to determine a variation voltage vector depending on the detected present current vector, to change the present operating point of the electric machine to a changed operating point by positioning the variation voltage vector such that the power generated by the change in the operating point is equal to or less than the power loss, particularly thermal power loss, of the electric machine, and to execute an active short-circuit state starting from the changed operating point. The control device can be formed, for example, as an inverter of the drive arrangement or of the motor vehicle, or the control device can comprise such an inverter.

One aspect of the invention is further directed to a drive arrangement which comprises an electric machine, an electrical energy storage and an above-described control device and a motor vehicle which comprises an above-described drive arrangement and/or an above-described control device.

All of the advantages, details and features which have been described with respect to the method are wholly transferable to the control device, the drive arrangement and the motor vehicle.

### BRIEF DECRIPTION OF THE DRAWINGS

The invention will be described in the following through embodiment examples referring to the drawings. The drawings are schematic depictions and show:

FIG. 1 is a schematic flow chart of a method for controlling the operation of an electric machine;

FIG. 2 is a schematic current diagram;

FIG. 3 is a schematic state diagram; and

FIG. 4 is a schematic voltage diagram.

### DETAILED DESCRIPTION OF THE PRESENTLY PREFERRED EMBODIMENTS

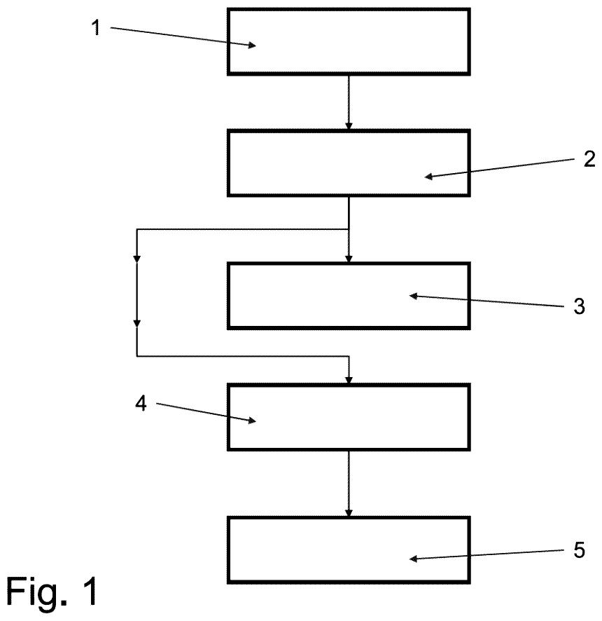

FIG. 1 shows, by way of example, the execution of the method described herein for controlling the operation of an electric machine, particularly a drive device of a motor vehicle, with reference to boxes 1-5. The electric machine can be a component part of a drive arrangement which comprises, for example, an electrical energy storage, an inverter and the electric machine. The inverter can be a component part of a control device or can form the control device which is configured to control the operation of the electric machine.

The method starts, by way of example, in block 1 in which a fault condition of the electric machine exists or is detected. In block 1, it can be decided whether or not to carry out the method described herein. For example, if no fault condition exists, the electric machine can continue to be operated normally. If the fault condition is detected, it can be determined, for example, whether the electrical energy storage is electrically coupled to the drive arrangement or whether a so-called battery dump has been carried out in which the electrical energy storage has been electrically decoupled from the drive arrangement so that an electrical connection no longer exists. In such a case, for example, no electrical energy can be drawn from the electrical energy storage by the electric machine and no electrical energy can be fed into the electrical energy storage.

Optionally, further operational events of the motor vehicle, electric machine or drive arrangement can be detected, for example, whether or not an accident state or crash state exists. Optionally, the operating temperature of the electric machine or whether the present operating temperature lies above or below a temperature limit value can further be detected in block 1. The method described herein is carried out in particular when the operating temperature of the electric machine lies above the temperature limit, since there is then a higher probability of a demagnetization of the permanent magnets of the electric machine. Block 1 proceeds to block 2 if it is determined in block 1 that a fault condition exists or is imminent, requiring that the method be carried out.

In an embodiment form of the method, blocks 2-4 can be carried out cyclically during the operation of the electric machine or of the drive arrangement so that the steps for determination or detection which are described in the following referring to blocks 2-4 are already executed and the process of working through blocks 2-4 is limited to positioning the vectors which have already been determined. It is also possible that the vectors, particularly when there is sufficient computing power, are not determined until a fault condition occurs.

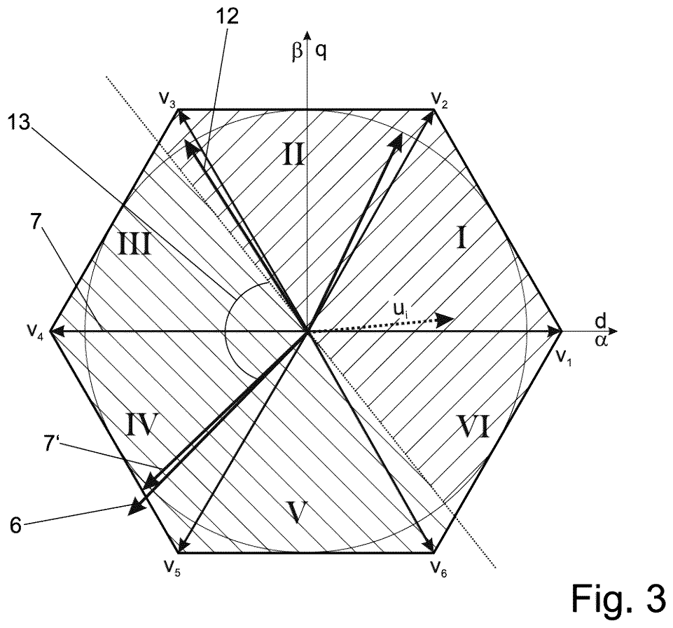

In block 2, the present current vector 6 or “current phasor” of the electric machine is detected. This is shown by way of example in FIG. 3 in the state diagram which shows the hexagon of the static switching states of the inverter, for example, in relation to a B6 bridge, in the form of vectors v1-v6. The latter delimit vector sectors I-VI from one another. In principle, any inverter or any control device can be used to control the electric machine. The corresponding state diagram is applicable to such cases and is merely illustrative in the present concrete example.

In the depicted exemplary aspect, the present current vector 6 lies, for example, between the static state vectors v4 and v5, i.e., in vector sector IV. However, the state is changeable as needed so that the current vector 6 can also lie in any other vector sector I-VI or on one of the state vectors v1-v6. As has been described, the current vector 6 can be determined cyclically automatically in the operating state so that the previously determined or detected current vector 6 can be directly outputted in block 2.

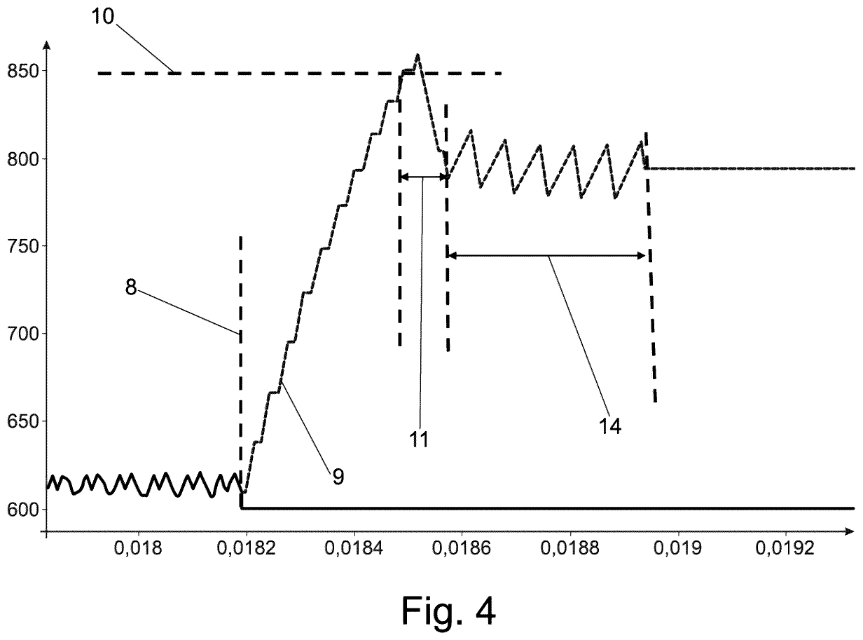

Optionally, block 2 can proceed to block 3 in which a discharge voltage vector 7 can be determined. For example, this can be carried out when the DC link voltage 9 (cf. FIG. 4) in the DC link lies above a defined voltage limit value 10. If the fault condition is detected, for example, starting from a generator mode of the electric machine, or the fault condition occurs in a generator mode of the electric machine so that no current can flow into the electrical energy storage due to the electric decoupling of the electrical energy storage, this results in a charging of the DC link so that the DC link voltage 9 is increased. If the latter lies above the voltage limit value 10, the voltage can initially be reduced by the discharge voltage vector 7 in order subsequently to improve or enable further prosecution of the method. The voltage limit value in FIG. 4 is, purely illustratively, approximately 850 V. The transition into time domain 14 occurs after the expiration of time period 11 which has been determined beforehand.

The discharge voltage vector 7 is shown in FIG. 3. The discharge voltage vector 7 can be positioned, for example, for a first time period 11 (cf. FIG. 4) or discharge time period. If the discharge voltage vector 7 is not positioned, block 2 can proceed directly to block 4. The discharge voltage vector 7 is determined depending on the detected current vector 6. To this end, it is sought that the discharge voltage vector 7 runs as parallel as possible to the current vector 6 so that active power can be generated in order to reduce the DC link voltage 9 in the DC link. An ideal discharge voltage vector 7′ is shown schematically in FIG. 3. Since the ideal discharge voltage vector 7′ lies between the static state vectors v4, v5, a comparatively elaborate control is needed for positioning the discharge voltage vector. To simplify the control, the discharge voltage vector 7 is advantageously fixed for the aforementioned first time period 11 on the static state vector v4 bounding vector sector IV in which the current vector 6 currently lies.

Purely by way of example, the current vector 6 currently lies in vector sector IV of the alpha-beta coordinate system which is bounded by state vectors v4, v5. Therefore, the discharge voltage vector 7 can be fixed, for example, on the rearward static state vector v4 which rearwardly bounds vector sector IV in which the current vector 6 presently lies. Alternatively, the discharge voltage vector 7 can also be positioned on the foreword state vector v5 which forwardly bounds the present vector sector iV. Accordingly, the control of the inverter can advantageously be kept particularly simple, because no modulation is required; rather, the switching position for the first time period 11 can be kept constant. Alternatively, a positioning of the discharge voltage vector 7′ is also possible, for example, when there is enough computing power or a sufficiently fast control is possible.

As has been described, the positioning of the discharge voltage vector 7 is purely optional and, in case it is not required by the DC link voltage 9 in the DC link, it can also be dispensed with. Purely by way of example, a fault condition in which the discharge voltage vector 7 is positioned is shown in FIG. 4. For example, a fault condition is detected starting from a regular operating state at time point 8 so that the electrical energy storage is decoupled. In the depicted exemplary embodiment, the electric machine was operated in generator mode so that the DC link voltage 9 increases as a result of the decoupling of the electrical energy storage.

By way of example, the DC link voltage 9 exceeds the voltage limit value 10 so that the discharge voltage vector 7 is positioned as has been described. Subsequently, as soon as the first time period 11 has expired, block 3 can proceed to block 4. In case the voltage limit value 10 is not exceeded, as was also previously described, for example, when the electric machine is operated in a motor mode, the positioning of the discharge voltage vector 7 can be omitted. For example, the discharge voltage vector 7 is positioned for the first time period 11. The first time period 11 can be set statically or determined depending on the present operating point, for example, by the DC link voltage. For example, the first time period 11 can be selected in such a way that the DC link voltage 9 falls below the voltage limit 10 again after the first time period 11 has expired.

In block 4, a variation voltage vector 12 is determined on the basis of the current vector 6 which was detected in block 2. As has been described, this can be carried out cyclically before the fault condition occurs. The variation voltage vector 12 is determined in the depicted embodiment example with a defined phase shift 13 with respect to the current vector 6. As was shown by way of example in FIG. 3, the variation voltage vector 12 is shifted by a phase angle in a range of π/2 with respect to the current vector 6. Alternatively, the phase shift can also take place in the opposite direction, i.e., in a range of −π/2 with respect to the current vector 6. As a result of this, no active power is generated by positioning the variation voltage vector 12 and the present operating point of the electric machine can accordingly be changed to a changed operating point without generating power. The phase angle or phase shift 13 can deviate from π/2 and, for example, can be in a range of from 250° to 270°, in particular 255° to 265°.

In so doing, a low active power is generated but is compensated by the losses within the electric machine so that the voltage in the DC link does not increase. The phase shift 13 can differ further from π/2 the more power loss is produced in the electric machine. To this end, there can be provided at least one power dissipation element, for example, a resistor, a varistor or the like, by which power can be selectively converted into heat. The power dissipation element is arranged, for example, in parallel with the DC link. Further, the phase shift 13 can also be determined depending on the operating point, for example, depending on the power dissipation actually produced in the electric machine. If high currents are flowing in the electric machine, for example, higher losses must be taken into account so that the phase shift 13 can be selected correspondingly higher.

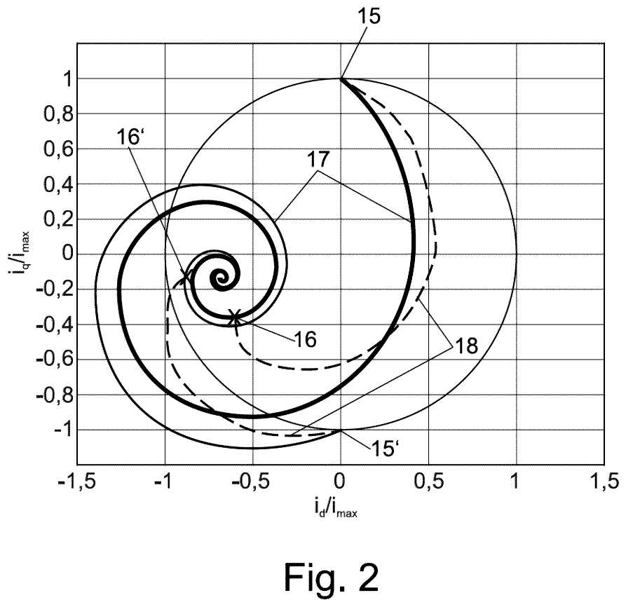

FIG. 4 shows that the variation voltage vector 12 is positioned for a second time period 14 or a variation time period. As a result, as is shown in FIG. 2 for two different present operating points 15, 15′, the change in the operating point has a curved path rather than a straight line. For example, a spiral path 17, 17′ is shown which represents a direct ASC circuit. The change in the operating point achieved by the variation voltage vector 12 is carried out on a curved path 18 from operating point 15, 15′ to operating point 16, 16′ (shown in dashes) and, therefore, on more direct paths compared with the spiral path 17. Accordingly, the operating point can come closer to a targeted operating point over the second time period 14, or the present operating point 15, 15′ can be approximated as closely as possible to the targeted operating point which represents the center point of the spiral. This means that the present operating point 15, 15′ can be changed to a changed operating point 16, 16′ which lies as close as possible to the center point of the spiral which corresponds to the stationary ASC current, and the depicted spiral is followed proceeding from the present operating points 15, 15′, and a changed operating point 16, 16′, shown by way of example, which lies on the spiral and is arranged as close as possible to the center point of the spiral is occupied at the end of the second time period 14.

The generated discharge voltage vector 7 and the generated variation voltage vector 12 can be produced statically so that they do not change over time periods 11, 14. It is also possible that the latter are updated with the rotating current phasor 6, i.e., continuously determined anew and positioned at different time points within the time periods 11, 14.

Setting the vectors 7, 12 statically offers the advantage that the computing expenditure and control expenditure can be appreciably reduced. If the latter are continually updated, the accuracy of the method can be improved.

Proceeding from the changed operating point 16, 16′ achieved in block 4, block 4 proceeds to block 5 in which the active short-circuit state can be carried out in order to bring the electric machine or the electric drive arrangement into the safe state. In FIG. 4, for example, the active short-circuit state follows the second time period 14. As will be seen, positioning the variation voltage vector 12 allows a power-neutral change in the operating point 15, 15′ into the changed operating point 16, 16′ so that no high transient currents can flow when passing into the active short-circuit state and also no strong opposing fields accordingly result. The proposed method accordingly makes it possible to eliminate or at least reduce corresponding rare earths in the electric machine without risking demagnetization in a fault condition, particularly a fault condition above a temperature limit when the electrical energy storage is decoupled.

As has been described, the method can be executed on a control device, particularly by an inverter. The control device or inverter and the electric machine can be component parts of a drive arrangement. The drive arrangement is arranged in particular in a motor vehicle. All of the details described with respect to the method are therefore also applicable to the control device, the drive arrangement and the motor vehicle. All of the advantages, details and features shown in the individual embodiment examples can be combined with one another, exchanged with one another and transferred to one another as needed.

Thus, while there have shown and described and pointed out fundamental novel features of the invention as applied to a preferred aspect thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method to control an operation of an electric machine in a fault condition, comprising:
detecting a present current vector of the electric machine;
determining a variation voltage vector depending on the detected present current vector;
changing a present operating point of the electric machine to a changed operating point by positioning the variation voltage vector, wherein a power generated by a change in the operating point is equal to a power loss of the electric machine, or is less than the power loss of the electric machine; and
executing an active short-circuit state proceeding from the changed operating point.

2. The method according to claim 1, wherein the variation voltage vector is determined with a defined phase shift in relation to the detected current vector.

3. The method according to claim 2, wherein the variation voltage vector is shifted by an additional shift relative to the detected current vector depending on at least one power dissipation element.

4. The method according to claim 1, wherein a discharge voltage vector is positioned before positioning the variation voltage vector to reduce the voltage, depending on the detected current vector.

5. The method according to claim 4, wherein the discharge voltage vector is positioned on a static state vector which bounds a vector sector in which the present current vector is detected.

6. The method according to claim 1, wherein an electric decoupling of an electrical energy storage and/or an operational event of the electric machine and/or of a motor vehicle having the electric machine, is detected as the fault condition depending on an operating temperature of the electric machine.

7. The method according to claim 4, wherein the discharge voltage vector and/or the variation voltage vector are positioned for a defined time period or variable time period.

8. The method according to claim 4, wherein the discharge voltage vector and/or the variation voltage vector are positioned statically or updated based on a change in the current vector.

9. The method according claim 4, wherein the discharge voltage vector and/or the variation voltage vector are determined cyclically before the fault condition occurs.

10. A control device configured to control an operation of an electric machine in a fault condition, wherein the control device detects a present current vector of the electric machine, to determine a variation voltage vector depending on the detected present current vector, to change the present operating point of the electric machine to a changed operating point by positioning the variation voltage vector such that a power generated by the change in the operating point is equal to a power loss, which is a thermal power loss, of the electric machine, or is less than the power loss, which is the thermal power loss, of the electric machine, and to execute an active short-circuit state starting from the changed operating point.

11. Drive arrangement comprising:
an electric machine;
an electrical energy storage; and
a control device configured to control an operation of an electric machine in a fault condition, wherein the control device detects a present current vector of the electric machine, to determine a variation voltage vector depending on the detected present current vector, to change the present operating point of the electric machine to a changed operating point by positioning the variation voltage vector such that a power generated by the change in the operating point is equal to a power loss, which is a thermal power loss, of the electric machine, or is less than the power loss, which is the thermal power loss, of the electric machine, and to execute an active short-circuit state starting from the changed operating point.

12. A motor vehicle comprising:
comprising:
an electric machine;
an electrical energy storage; and
a control device configured to control an operation of an electric machine in a fault condition, wherein the control device detects a present current vector of the electric machine, to determine a variation voltage vector depending on the detected present current vector, to change the present operating point of the electric machine to a changed operating point by positioning the variation voltage vector such that a power generated by the change in the operating point is equal to a power loss, which is a thermal power loss, of the electric machine, or is less than the power loss, which is the thermal power loss, of the electric machine, and to execute an active short-circuit state starting from the changed operating point.

13. The method according to claim 1, wherein the power loss is a thermal power loss.

14. The method according to claim 2, wherein the defined phase shift is in a range of +/−π/2.

15. The method according to claim 7, wherein the discharge voltage vector and/or the variation voltage vector are positioned for the defined time period or the variable time period depending on the present operating point.
